(19) United States
(12) Patent Application Publication
(10) Pub. No.: US 2004/0163783 A1
(43) Pub. Date: Aug. 26, 2004

(54) Method and device for producing a multi-ply web of flexible material, such as paper and nonwoven, and multi-ply material produced by the method

(75) Inventor: Heinz Jurgen Muller, Hans Holbein Strasse (DE)

Correspondence Address: BURNS, DOANE, SWECKER & MATHIS, L.L.P., P.O. Box 1404, Alexandria, VA, 22313-1404, US

(73) Assignee: SCA Hygiene Products GmbH

(21) Appl. No.: 10/788,483

(22) Filed: Mar. 1, 2004

Related U.S. Application Data
(62) Division of application No. 10/118,895, filed on Apr. 10, 2002.
(60) Provisional application No. 60/282,464, filed on Apr. 10, 2001.

(30) Foreign Application Priority Data
Apr. 10, 2001 (GB) GB 0108997.8

(51) Int. Cl. B31F 1/07; D21H 27/30; D21H 27/40

(52) U.S. Cl. 162/132; 162/117; 156/209

(57) ABSTRACT

A method for producing a multi-ply web of flexible material, such as paper and nonwoven material. At least one first ply is separately embossed by a first embossing means to form a plurality of crests and depressions and is combined with at least one second ply. After combining the first and second plies, they are brought into a nip between a spiked roll and a smooth rigid roll, the spiked roll having a plurality of protuberances which are adapted to press together the first and second plies in points or spots to cause a mechanical ply bonding between the at least two plies. The first embossing means and the spiked roll are in register with each other so that the protuberances of the spiked roll will hit at least some of the depressions of the ply facing the spiked roll. The invention also refers to a multi-ply web produced by the method.

### TECHNICAL FIELD

The present invention refers to a method for producing a multi-ply web of flexible material, such as paper and nonwoven material, in which at least one first ply is separately embossed by a first embossing means to form a plurality of crests and depressions and is combined with at least one second ply to form said multi-ply web, Especially it refers to production of tissue products such as toilet and kitchen paper, paper towels, handkerchiefs, wiping material and the like. The invention further refers to a multi-ply web of flexible material, such as paper and nonwoven, comprising at least a first and a second ply.

### BACKGROUND OF THE INVENTION

It is very common to laminate two or more tissue plies in order to produce the final tissue product. Herewith a more flexible and softer tissue product is obtained as compared to if one single ply with a corresponding thickness and basis weight had been produced as for the laminated product. The absorbent capacity and the bulk are moreover improved.

The lamination of tissue plies can be made by embossing without any addition of glue, at which a mechanical joining of the plies occur in the embossing sites. The embossing and ply bonding usually takes place in one step. One example of such a lamination process is found in DE-A-196 26 997 disclosing a method where layers of tissue are mechanically joined together in a nip between an embossing roll provided with protrusions and a smooth steel roll. The tissue layers are mechanically welded in the embossing spots and the protrusions will exert a limited adhesion force on the tissue at the withdrawal of the protrusions, so that the tissue will be carried along a certain distance, thus leaving a three-dimensional surface structure also on the side of the tissue that has been facing the smooth steel roll.

Another example of a lamination process in which embossing and ply bonding takes place in the same step is found in DE-A-196 54 249 in which a pair of steel embossing rolls are used in the bonding process. Each roll has embossing protrusions which extend into the space between the protrusions of the opposite roll. A similar embossing and lamination process is found in DE-A-298 08 740.

The lamination of two or more tissue plies can also be made by gluing. A mechanical embossing of the plies is also often performed before they are glued together. Through for example EP-A-796 727 it is known to first emboss two paper plies in a three dimensional structure with alternating raised and recessed portions, after which glue is applied to one of the plies and the two plies are joined in a press nip between two embossing rolls, so that the raised portions of the respective plies are glued to each other. A similar embossing procedure is shown in EP-A-738 588, according to which the glue also has a colouring effect.

Through U.S. Pat. No. 5,443,889 there is known a procedure for laminating two paper plies, which are fed over a pattern roll each, said pattern rolls having alternating raised and recessed portions and where glue is applied to one ply while this is led over the roll. The two paper plies are then glued together in a nip between the two pattern rolls, which are in register with each other so that a joining and compression of the paper plies occurs in a pattern corresponding to the raised portions of the pattern rolls.

### OBJECT AND MOST IMPORTANT FEATURES OF THE INVENTION

The object of the present invention is to provide a method for producing a multi-ply web of flexible material, such as paper and nonwoven, wherein at least two plies of flexible material are laminated together. The lamination should be made in a mechanical way without the use of glue. The bonding sites should not protrude from the material layers but be discrete and more or less invisible and thus not disturb the visual appearance of the final product. The laminated products should be soft and pliable and it should be possible to choose an embossing pattern with a high degree of freedom.

This has according to the invention been provided by the fact that after combining the first and second plies, at least one of which being pre-embossed, they are brought into a nip between a spiked roll and a smooth rigid roll, said spiked roll having a plurality of protuberances which are adapted to press together the first and second plies in points or spots to cause a mechanical ply bonding between the at least two plies, and wherein the first embossing means and said spiked roll are in register with each other so that the protuberances of the spiked roll will hit the depressions of the ply facing the spiked roll.

According to a preferred embodiment the second ply is separately embossed by a second embossing means to form a plurality of crests and depressions before it is combined with the at least one first ply.

The embossing patterns of the first and second embossing means are preferably in register with each other in a manner in which the crests of the inner surface of one ply are received in the depressions of the inner surface of the opposite ply.

The invention further refers to a multi-ply web of flexible material, such as paper and nonwoven, comprising at least a first and second ply at least one of which is embossed to form a plurality of crests and depressions, said plies being bonded together by mechanical ply bonding, wherein said bonding spots or points are located in at least some of the depressions of one embossed side of the paper product and are of a smaller dimension as compared to the dimension of the bottom of the depressions.

Preferably said bonding spots or points will not protrude from the opposite side of the multi-ply web.

The term spots in this respect refers to any shape of the bonding sites, such as small points, lines or any desired geometrical shape.

Further features of the invention are disclosed in the following description and in the claims.

### DESCRIPTION OF DRAWINGS

The invention will in the following be closer described with reference to an embodiment shown in the accompanying drawings.

FIG. 1 shows a schematic side view of a device for performing the method according to the invention.

FIG. 2 is a schematic cross section on a larger scale of two combined pre-embossed paper plies before bonding.

FIG. 3 is schematic side view of the bonding station in which the plies are mechanically joined together.

FIG. 4 is a schematic plan view on an enlarged scale of a multi-ply web according to the invention.

### DESCRIPTION OF AN EMBODIMENT

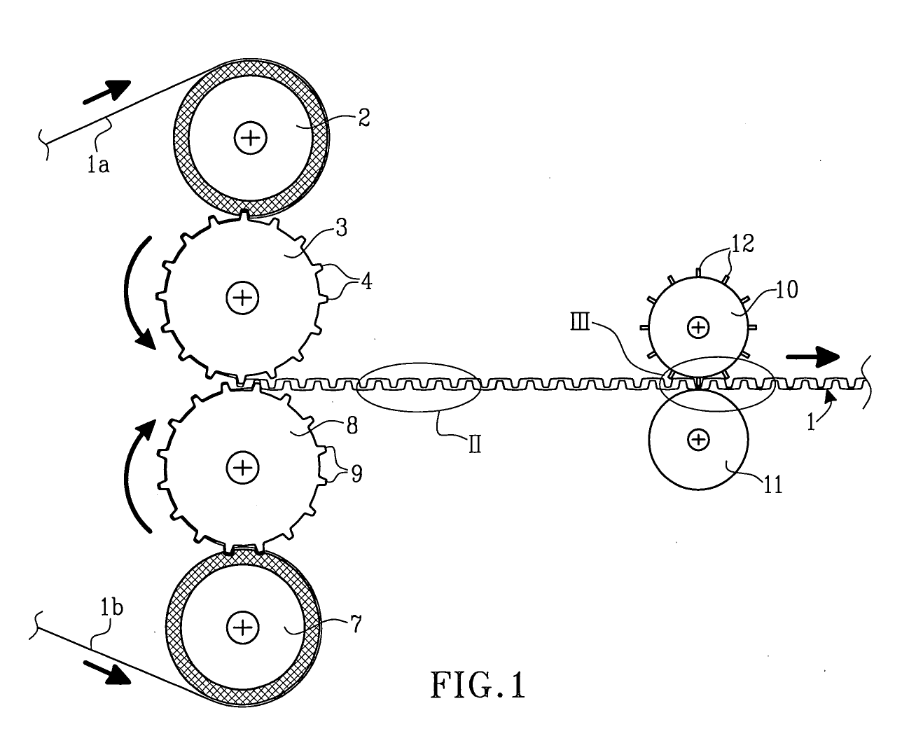

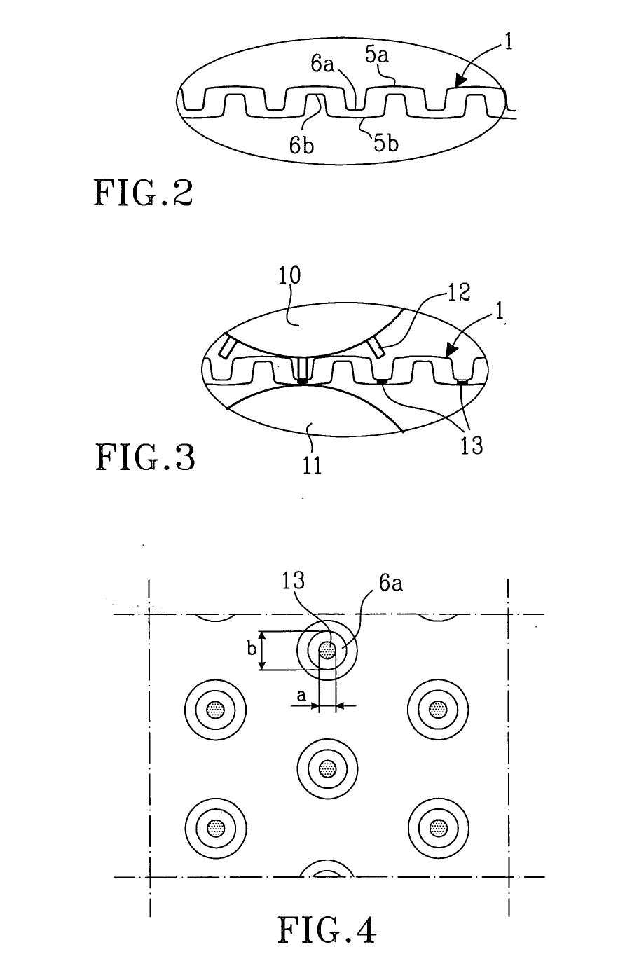

FIG. 1 shows a device for producing a two-ply material, e g paper, especially tissue paper. A first paper web 1a is fed to a first embossing station comprising a rubber roll 2 and an embossing roll 3. The embossing roll 3 is along its periphery provided with a pattern of protrusions 4 intended to provide the desired embossing pattern in the paper web 1a with alternating crests 5a and depressions 6a.

A second paper web 1b is fed to a second embossing station comprising a rubber roll 7 and an embossing roll 8. The embossing roll 8 is along its periphery provided with a pattern of protrusions 9 intended to provide a desired embossing pattern in the paper web 1b with alternating crests 5b and depressions 6b. The pattern is preferably the same as the embossing pattern provided by the first embossing roll 3. Slightly different patterns may be used, but it is important that the patterns are in register with each other, so that the crests of the first ply can be received in the depressions of the second ply and vice versa.

The embossing stations may instead of embossing roll and rubber roll comprise two matched steel rolls, i e two steel rolls with matching patterns which provide the desired embossing pattern in the paper web. Instead of a rubber roll there may also be used a paper roll in which cavities are formed by the embossing roll.

The first and second embossing rolls 3 and 8 are driven in register with each other so that the crests 5a of the inner surface of the first ply 1a are received in the depressions 6b of the inner surface of the second ply 1b and the crests 5b of the inner surface of the second ply 1b are received in the depressions 6b of the inner surface of the first ply.

The combined plies 1a and 1b are brought into a nip between a spiked roll 10 and a smooth steel roll 11. The spiked roll 10 has a plurality of protuberances 12 which are adapted under a high pressure to press together the first and second plies 1a and, 1b in points or spots to cause a mechanical ply bonding or mechanical welding of the plies 1a and b. No glue is needed for achieving the bonding between the plies.

The embossing rolls 3 and 8 and said spiked roll 10 are in register with each other so that the protuberances 12 of the spiked roll 10 will hit the depressions of the ply 1a facing the spiked roll. The bonding points 13 will be hardly visible and thus not disturb the visual appearance of the paper product. The protuberances 12 are preferably of a smaller cross-sectional dimension as compared to the depressions formed by the embossing roll 3. The protuberances 12 of the spiked roll may be arranged with the same density as the pattern of the embossing rolls 3 and 8 or be more sparsely arranged so that they will not hit every depression of the ply 1a.

Since the counter roll 11 is a smooth steel roll the protuberances 12 of the spiked roll 10 will not penetrate the paper plies and thus no markings will be seen on the side of the paper web facing the steel roll 11. This will also result in a soft product.

It is understood that one or each of the plies 1a and 1b may comprise two or more plies which are embossed together in the respective embossing station. Thus the final paper product may have two, three or more plies.

It also encompassed by the present invention that only one ply 1a or 1b is embossed, while the other ply is brought in a smooth non-embossed condition to the bonding station between the spiked roll 10 and the smooth steel roll 12.

The paper product obtained by the method is characterized by comprising two or more plies, at least one of which is embossed to form a plurality of crests and depressions. The plies are bonded together in points or spots by mechanical welding, said bonding spots or points being located in at least some of the depressions of one embossed side of the paper product and will not protrude from the opposite side of the paper product. The bonding spots or points 13 are of a smaller dimension a as compared to the dimension b of the bottom of the depressions 6a (FIG. 4).

In case both plies are pre-embossed the embossment patterns should be in register so that the crests of the inner surface of one ply are received in the depressions of the inner surface of the opposite ply.

1. A method for producing a multi-ply web of flexible material, the method comprising:
separately embossing at least one first ply by a first embossing means to form a plurality of crests and depressions;
combining the at least one first ply with at least one second ply to form the multi-ply web; and
after combining the first and second plies, bringing the first and second plies into a nip between a spiked roll and a smooth rigid roll, the spiked roll having a plurality of protuberances adapted to press together the first and second plies in points or spots to cause a mechanical ply bonding between at least the first and second plies, and wherein the first embossing means and the spiked roll are in register with each other so that the protuberances of the spiked roll will hit at least some of the depressions of the ply facing the spiked roll.

2. The method as claimed in claim 1, comprising:
separately embossing the second ply by a second embossing means to form a plurality of crests and depressions before the second ply is combined with the first ply.

3. The method as claimed in claim 2, wherein embossing patterns of the first embossing means and the second embossing means are in register with each other in a manner in which crests of the inner surface of one ply are received in depressions of the inner surface of an opposite ply.

4. The method as claimed in claim 1, wherein a cross-sectional dimension (a) of the protuberances of the spiked roll is smaller than a cross-sectional dimension (b) of the depressions which the protuberances are intended to hit.

5. A multi-ply web of flexible material, the multi-ply web comprising at least one first ply and one second ply, at least one of which is embossed to form a plurality of crests and depressions, the at least one first ply and at least one second play being bonded together by mechanical ply bonding, wherein bonding spots or points are located in at least some of the depressions of one embossed side of the paper product and the bonding spots or points are of a smaller dimension (a) as compared to a dimension (b) of a bottom of the depressions.

6. The multi-ply web as claimed in claim 5, wherein the bonding spots or points will not protrude from an opposite side of the multi-ply web.

7. The method as claimed in claim 1, wherein the multi-ply web comprises a paper and a non-woven.

8. The method as claimed in claim 5, wherein the multi-ply web comprises a paper and a non-woven.
